(19) United States
(12) Patent Application Publication
(10) Pub. No.: US 2023/0056950 A1
(43) Pub. Date: Feb. 23, 2023

(54) ADVERTISEMENT SERVICE SYSTEM FOR DETERMINING PRIORITY FOR EACH ADVERTISEMENT BY REFERENCE AREA AND TAGS

(71) Applicant: ALTSOFT. INC., Seoul (KR)

(72) Inventor: Chan Hong KIM, Seoul (KR)

(21) Appl. No.: 17/981,271

(22) Filed: Nov. 4, 2022

Related U.S. Application Data
(63) Continuation of application No. PCT/KR2021/006388, filed on May 23, 2021.

(30) Foreign Application Priority Data
May 28, 2020 (KR) 10-2020-0063946

(51) Int. Cl. G06Q 30/02

(52) U.S. Cl. CPC G06Q 30/0261; G06Q 30/0267

(57) ABSTRACT

An advertisement service system for determining a priority for each advertisement by using a reference area and tags is proposed. According to the advertisement service system for determining the priority for each advertisement by using the reference area and the tags, the priority of each advertisement is set by using the reference area and the tags of each advertisement together, so that the priority for each advertisement is set according to extra points granted to the respective tags, thereby solving the problem of using only the reference area and effectively setting the priority. In addition, according to the advertisement service system, the extra points respectively granted to the tags are changed according to change criteria different from each other for each tag, so that the priority may be set to increase users' interest in the entire advertisement provided to users and maximally improve an advertisement effect.

### CROSS-REFERENCE TO RELATED APPLICATIONS

This application is a continuation of Application No. PCT/KR2021/006388 filed on May 23, 2021, which in turn claims the benefit of Korean Patent Application No. 10-2020-0063946 filed on May 28, 2020, the disclosures of which are incorporated by reference into the present application.

### TECHNICAL FIELD

The present disclosure relates to an advertisement service system and, more particularly, to an advertisement service system for determining a priority for each advertisement by a reference area and tags.

### BACKGROUND ART

Conventionally, advertisements are provided through mass media such as newspapers, magazines, radio, and broadcasting. However, as the number of users accessing media through mobile devices increases exponentially with the development of mobile communication technology, attempts to provide the advertisements through the mobile devices have begun. In conventional advertisements through the mass media, the advertisements are unilaterally provided to an unspecified number of people, so there is a limitation in that personalized advertisements are unable to be provided to the users. However, the advertisements through the mobile devices have an advantage in that the personalized advertisements may be provided to the users by utilizing user's various information collected from the mobile devices. Accordingly, customized advertisements may be more effectively provided to the users, and thus the advertisements through the mobile devices are positioned as one of the most important advertisement means.

Meanwhile, as the mobile devices are widely distributed to the users, advertisements using location information of the mobile devices are being provided. When the location information collected through GPS modules of the mobile devices is used, the personalized advertisements may be provided to the users. For example, when users are currently at “Gangnam-gu Office Station”, an advertisement for a company in the vicinity of the “Gangnam-gu Office Station” may be provided to the users. That is, since the advertisement is provided by using the location information of the users and a location of an advertiser, the advertisement may be more effectively provided to the users.

However, in some business fields, when an advertisement is provided to users, it is often required to consider a location where the advertisement should be exposed, rather than a physical location of an advertiser. For example, in a case of a software company, it is effective for the company to expose an advertisement in a place where users using relevant software are mainly concentrated, regardless of a physical location of the corresponding company. As in the related art, when an advertisement is provided by using the advertiser's physical location, there is a problem in that the advertisement may not be effectively carried out for the users in a corresponding business field.

In order to solve such a problem, Korean Patent No. 10-1914588, “BANNER ADVERTISEMENT SERVICE SYSTEM IN WHICH PRIORITIES OF BANNER ADVERTISEMENT IS DETERMINED BY REFERENCE REGION” has been proposed.

However, in a process of actually applying the corresponding technology, as an advertisement with a low interest level is exposed at the top, a problem occurs that user's interest in the entire advertisement provided may be lowered. Therefore, the development of a technology for solving such a problem and for providing advertisements by effectively determining priorities is required.

### DISCLOSURE

### Technical Problem

The present disclosure has been proposed to solve the above problems of the previously proposed methods, and an objective of the present disclosure is to provide an advertisement service system for determining a priority for each advertisement by a reference area and tags, wherein the priority of each advertisement is set by using the reference area and the tags of each advertisement together, so that the priority for each advertisement is set according to extra points respectively granted to the tags, thereby solving the problem of using only the reference area and effectively setting the priority.

In addition, another objective of the present disclosure is to provide an advertisement service system for determining a priority for each advertisement by a reference area and tags, wherein extra points respectively granted to the tags are changed according to change criteria different from each other for each tag, so that the priority may be set to increase users' interest in the entire advertisement provided to users and maximally improve an advertisement effect.

### Technical Solution

According to features of the present disclosure for achieving the above objectives, there is provided an advertisement service system for determining a priority for each advertisement by using a reference area and tags,

the advertisement service system providing the advertisements and including:

a service provision server configured to receive advertisement requests from a local device, and provide the advertisements to the local device,

wherein the service provision server includes:

a database module configured to receive and store inputs of content to be displayed as the advertisements and the reference areas independent of a location of an advertiser;

a tag setting module configured to set the tags in the advertisements;

an extra point granting module configured to grant extra points to the respective tags, and change the extra points granted according to change criteria different from each other for each tag;

a priority setting module configured to set priorities of the advertisements according to the reference areas and the extra points granted to the respective tags of the advertisements stored in the database module on the basis of the location specified by location information of the local device; and

an advertisement provision module configured to arrange the advertisements stored in the database module according to the priorities set by the priority setting module and provide the advertisements to the local device,

wherein the priority setting module

may be characterized in a configuration thereof to set the priorities of the advertisements according to the extra points granted to the respective tags set in the advertisements when the reference areas of the advertisements stored in the database module include the location specified by the location information of the local device.

Preferably, the tag setting module

may set, to the advertisements, at least one or more tags among tags selected by the advertiser and tags automatically selected according to the advertisements.

More preferably, the tag setting module

may periodically update and reset the tags automatically selected according to the advertisements.

Preferably, the change criteria

may be preset according to characteristics of the tags.

Preferably, the change criteria

may be extra points preset for each round of exposure or extra points preset according to time of the advertisements.

Preferably, the priority setting module

may set the priorities of the advertisements in an order in which the extra points granted to the respective tags set in the advertisements are highest.

Preferably, the priority setting module

may set the priorities of the advertisements in which the reference areas of the advertisements stored in the database module include the location specified by the location information of the local device to be higher than the priorities of the advertisements in which the reference areas of the advertisements stored in the database module do not include the location specified by the location information of the local device.

More preferably,

when the reference areas of the advertisements stored in the database module do not include the location specified by the location information of the local device, the priority setting module may set the priorities of the advertisements in an order in which shortest distances between the position specified by the location information of the local device and boundary lines of the respective reference areas of the advertisements are shortest.

Even more preferably,

when the shortest distances are the same, the priority setting module may set the priorities of the advertisements in an order in which the reference areas of the advertisements are widest.

### Advantageous Effects

According to the advertisement service system for determining the priority for each advertisement by using the reference area and the tags, which are proposed in the present disclosure, the priority of each advertisement is set by using the reference area and the tags of each advertisement together, so that the priority for each advertisement is set according to the extra points respectively granted to the tags, thereby solving the problem of using only the reference area and effectively setting the priority.

In addition, according to the advertisement service system for determining the priority for each advertisement by using the reference area and the tags, which are proposed in the present disclosure, the extra points respectively granted to the tags are changed according to the change criteria different from each other for each tag, so that the priority may be set to increase the users' interest in the entire advertisement provided to the users and maximally improve the advertisement effect.

### DESCRIPTION OF DRAWINGS

FIG. 1 is a view illustrating a configuration of an advertisement service system for determining a priority for each advertisement by a reference area and tags according to an exemplary embodiment of the present disclosure.

FIG. 2 is a view illustrating a detailed configuration of a service provision server in the advertisement service system for determining the priority for each advertisement by using the reference area and the tags according to the exemplary embodiment of the present disclosure.

FIG. 3 is a view illustrating extra point change criteria for each tag in the advertisement service system for determining the priority for each advertisement by using the reference area and the tags according to the exemplary embodiment of the present disclosure.

FIG. 4 a view illustrating reference areas in the advertisement service system for determining the priority for each advertisement by using the reference area and the tags according to the exemplary embodiment of the present disclosure.

FIG. 5 is a view illustrating a state in which priorities are set in a priority setting module of the advertisement service system for determining the priority for each advertisement by using the reference area and the tags according to the exemplary embodiment of the present disclosure.

FIG. 6, FIG. 7 and FIG. 8 are views respectively illustrating states in which priorities for advertisements B, C, and D are set by using extra points in the priority setting module of the advertisement service system for determining the priority for each advertisement by using the reference area and the tags according to the exemplary embodiment of the present disclosure.

### DESCRIPTION OF THE REFERENCE NUMERALS IN THE DRAWINGS

100: service provision server

110: database module

120: tag setting module

130: extra point granting module

140: priority setting module

150: advertisement provision module

200: local device

### BEST MODE

Hereinafter, a preferred exemplary embodiment will be described in detail with reference to the drawings accompanied in this specification so that those skilled in the art may easily implement the present disclosure. However, in the following detailed description of the preferred exemplary embodiment of the present disclosure, it is to be noted that, when the detailed description of a related known function or configuration may unnecessarily obscure the subject matter of the present disclosure, the detailed description thereof will be omitted. In addition, the same reference numerals are used throughout the drawings for parts having similar functions and actions.

In addition, throughout the specification, when a part is said to be “connected” to another part, an expression such as “connected” is intended to include not only “directly connected” but also “indirectly connected” having a different component in the middle thereof. In addition, unless the context clearly indicates otherwise, it will be further understood that the terms “comprises”, “comprising”, “includes”, and/or “including” specify the presence of other components, but do not preclude the presence or addition of one or more other components thereof.

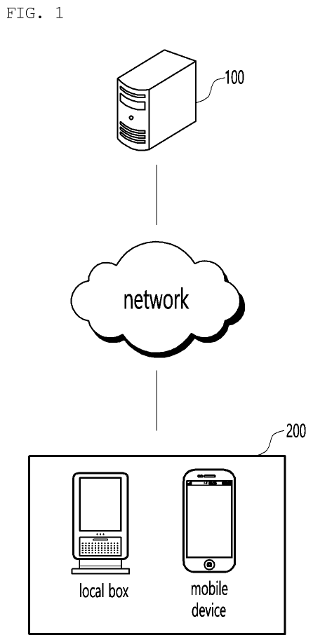

FIG. 1 is a view illustrating a configuration of an advertisement service system for determining a priority for each advertisement by a reference area and tags according to the exemplary embodiment of the present disclosure. As shown in FIG. 1, the advertisement service system for determining the priority for each advertisement by using the reference area and the tags according to the exemplary embodiment of the present disclosure may be configured to include a service provision server 100 and a local device 200.

The service provision server 100 may receive advertisement requests from the local device 200 and provide advertisements to the local device 200. Here, that the service provision server 100 provides the advertisements to the local device 200 refers that data about the advertisements to be displayed on a display of the local device 200 are transmitted to the local device 200 through a network. The data for the advertisements may be data including at least one or more pieces of data selected from a group including text, images, sounds, videos, multimedia, and the like, and the advertisements may be not only general commercial advertisements, but also all kinds of content such as advertisement information, story information, public information, etc. For example, each advertisement may be in various forms such as a post or notice form, a story form, an announcement form, an image form, a video form, and the like.

The local device 200 may be a device capable of transmitting and receiving data to and from the service provision server 100 through the network. Here, the local device 200 may include a local box or a mobile device, as shown in FIG. 1.

The local box is a device including a display unit, and may be in a form of a kiosk, signage, or the like. In addition, the local box may be a device capable of transmitting and receiving data to and from the service provision server 100 through the network. Accordingly, the local box may receive the data about advertisements from the service provision server 100 and output the advertisements to the display unit. Meanwhile, any device capable of transmitting and receiving the data to and from the service provision server 100 through the network and outputting the advertisements through the display unit may be included in the local box regardless of a specific type thereof.

The mobile device may include devices such as a smartphone, a tablet PC, and a wearable device. However, the mobile device 200 is not limited to the types of the devices described above, and any device capable of transmitting and receiving the data to and from the service provision server 100 through the network and outputting the advertisements through the display unit may be included in the mobile device regardless of a specific type thereof.

Meanwhile, in the present disclosure, the network may be implemented by using: a wired network such as a Local Area Network (LAN), a Wide Area Network (WAN), or a Value Added Network (VAN); or all kinds of wireless networks such as a Mobile Radio Communication Network, a Satellite Network, Bluetooth, a Wireless Broadband Internet (WIBRO), High Speed Downlink Packet Access (HSDPA), Long-Term Evolution (LTE), and 5th Generation Mobile Telecommunication (5G).

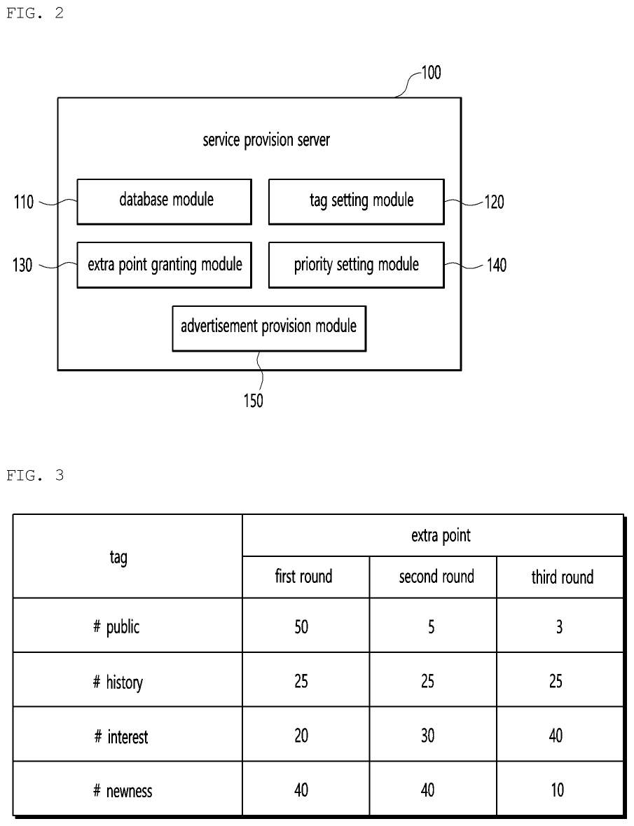

FIG. 2 is a view illustrating a detailed configuration of a service provision server 100 in the advertisement service system for determining the priority for each advertisement by using the reference area and the tags according to the exemplary embodiment of the present disclosure. As shown in FIG. 2, the service provision server 100 of the advertisement service system for determining the priority for each advertisement by using the reference area and the tags according to the exemplary embodiment of the present disclosure may be configured to further include a database module 110, a tag setting module 120, an extra point granting module 130, a priority setting module 140, and an advertisement provision module 150. Hereinafter, each configuration of the service provision server 100 will be described in detail.

The database module 110 may receive and store inputs of content to be displayed as advertisements and reference areas independent of a location of an advertiser. Here, the content may be data including text, images, sounds, videos, etc. Meanwhile, a reference area may be used to set a priority of an advertisement in the priority setting module 140 to be described later. Since the advertisement has the highest priority in the reference area, the reference area corresponds to an area where the advertisement may be most exposed to users. Such a reference area may be set through an advertiser's device (not shown), and may be independent of an advertiser's physical location. That is, even though the advertiser is in an “A” area, the reference area of the advertisement may be set with a “B” area.

Meanwhile, according to the exemplary embodiment, an extent of the reference area may be determined according to an advertisement cost. Alternatively, the extent of the reference area may be determined independently by the service provision server 100 using a popularity level or a recommendation level of content independent of the advertisement cost. For example, when a popularity level of content of an advertisement A is higher than that of content of an advertisement B, an extent of a reference area of the advertisement A may be determined to be wider than that of the advertisement B. However, the extent of the reference area is not only determined by the above-described exemplary embodiment, but may also be determined by various methods.

In addition, the database module 110 may receive and store inputs of a plurality of reference areas for one advertisement. Since each reference area of the advertisement may be independently set in a plurality of areas without being dependent on the physical location of the advertiser, the advertisement may be more effectively exposed to the users through the plurality of reference areas.

The tag setting module 120 may set a tag for an advertisement, and at least one or more tags may be set for one advertisement. In this case, the tags may indicate characteristics of the advertisement. For example, an advertisement may be content of a story. Depending on the content of the story, the tag is “public” when the content is public information, the tag is “history” when the content is about history, the tag is “newness” when a first delivery date is within a predetermined period, the tag is “interest” when a response to the advertisement is high, and the like, and thus the tag may vary depending on the content of the advertisement. Further, the tag may be a business type of advertisement companies such as restaurants, banks, lodgings, and cafes.

Meanwhile, the tag setting module 120 may set, to an advertisement, at least one or more tags among tags selected by an advertiser and tags automatically selected according to the advertisement. That is, the tags set in the advertisement by the tag setting module 120 may include the tags directly selected by the advertiser, or may include the tags automatically selected by the tag setting module 120 of the service provision server 100. For example, the advertiser may select a tag such as a business type, and the tag setting module 120 may select a tag such as “interest”, “popularity”, and the like by using the popularity level and the recommendation level of the advertisement.

In addition, the tag setting module 120 may periodically update and reset the tags automatically selected according to the advertisement. In particular, by periodically updating and resetting the tags such as interest, popularity, and newness, the tags set in the specific advertisement may be changed according to circumstances. In addition, the tags selected by the advertiser may also be reset according to changing of the tags by the advertiser.

The extra point granting module 130 may grant an extra point to a tag, but may change the extra point according to change criteria different from each other for each tag. In this case, the change criteria may be extra points preset for each round of exposure of the advertisement or extra points preset according to time of the advertisement. The change criteria may be preset according to characteristics of each tag.

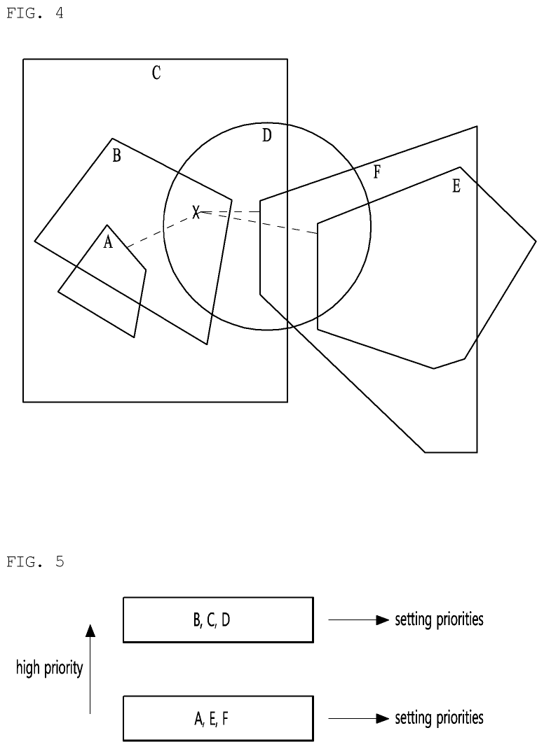

FIG. 3 is a view illustrating extra point change criteria for each tag in the advertisement service system for determining the priority for each advertisement by using the reference area and the tags according to the exemplary embodiment of the present disclosure. As shown in FIG. 3, in the advertisement service system for determining the priority for each advertisement by using the reference area and the tags according to the exemplary embodiment of the present disclosure, the change criteria may be prepared by setting extra points differently for each round of exposure, such as first exposure (i.e., a first time), second exposure (i.e., a second time), and third exposure (i.e., a third time), whereby the extra points may be changed according to the change criteria. For example, as for an advertisement with a public tag, users tend to get bored of frequent exposure, but such an advertisement corresponds to an advertisement that should be provided, so a high extra point is granted in the first exposure and the high extra point may be changed to a very low extra point in the second and third rounds of the exposure.

On the basis of a location specified by location information of the local device 200, the priority setting module 140 may set priorities of advertisements according to extra points respectively granted to reference areas and tags of the advertisements stored in the database module 110.

In this case, when the reference areas of the advertisements stored in the database module 110 include the location specified by the location information of the local device 200, the priority setting module 140 may set the priorities of the advertisements according to the extra points granted to the respective tags set in the advertisements. More specifically, the priority setting module 140 may set the priorities of the advertisements in an order in which the extra points granted to the respective tags set in the advertisements are higher.

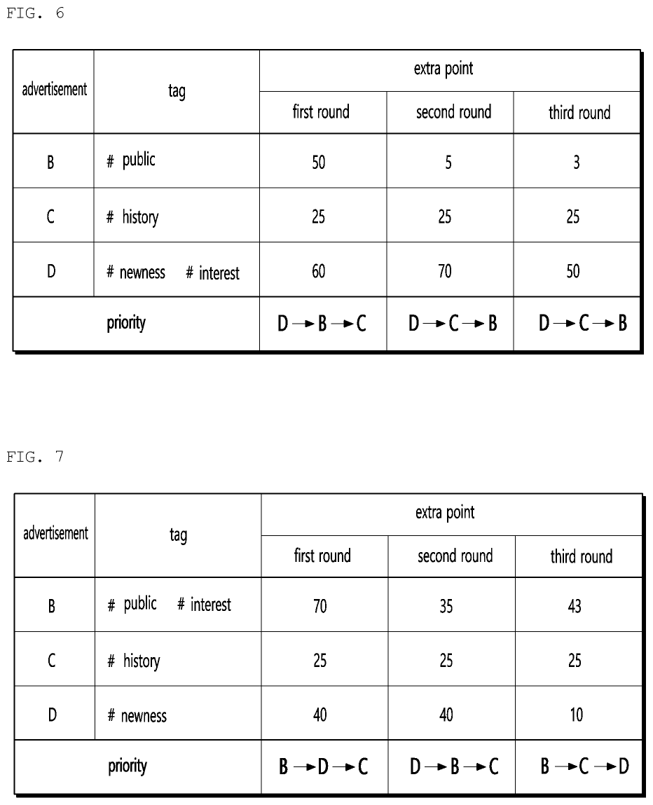

A detailed method of setting a priority of each advertisement by using a reference area and tags will be described in detail later with reference to FIGS. 4 to 6.

The advertisement provision module 150 may arrange advertisements stored in the database module 110 according to priorities set in the priority setting module 140 and provide the arranged advertisements to the local device 200. That is, the advertisement provision module 150 may transmit data on the advertisements respectively having priorities set therein to the local device 200 through the network. The local device 200 may output, on a display, the data on the advertisements respectively having priorities set therein and received from the advertisement provision module 150, so that advertisement content may be displayed to users according to the priorities.

FIG. 4 a view illustrating reference areas in the advertisement service system for determining the priority for each advertisement by using the reference area and the tags according to the exemplary embodiment of the present disclosure. Hereinafter, a configuration for setting the priority of each advertisement in the priority setting module 140 will be described in a case where reference areas A, B, C, D, E, and F of respective advertisements A, B, C, D, E, and F are set as in the example shown in FIG. 4, a location specified by the location information of the local device 200 is X, and extra point change criteria for each tag are as shown in FIG. 3.

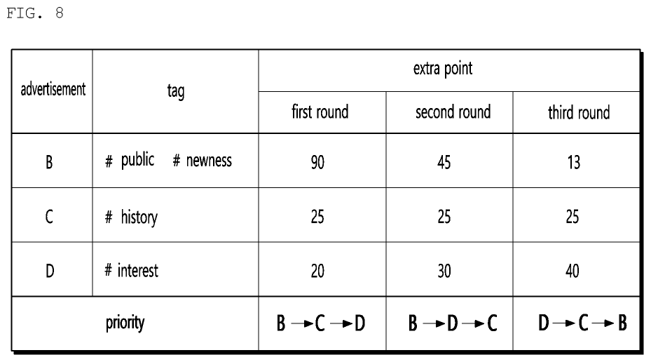

FIG. 5 is a view illustrating a state in which priorities are set in a priority setting module of the advertisement service system for determining the priority for each advertisement by using the reference area and the tags according to the exemplary embodiment of the present disclosure. As shown in FIG. 5, the priority setting module 140 may set a priority of each advertisement including the location where reference areas of the advertisements stored in the database module 110 are specified by the location information of the local device 200 to be higher than a priority of each advertisement not including the location where the reference areas of the advertisement stored in the database module 110 are specified by the location information of the local device 200.

That is, referring to FIG. 4, the location X specified by the location information of the local device 200 is included in the reference areas B, C, and D, but is not included in the reference areas A, E, and F. As shown in FIG. 5, the priority setting module 140 may set the priorities for the respective reference areas B, C, and D, which include the location X specified by the location information of the local device 200, to be higher than the priorities for the respective reference areas A, E, and F. Accordingly, the priority setting module 140 may set the priorities of advertisements B, C, and D respectively having the reference areas B, C, and D to be higher than the priorities of advertisements A, E, and F respectively having the reference areas A, E, and F.

Next, the priorities between the advertisements B, C, and D are set according to the extra points granted to respective tags of the advertisements B, C, and D, and the priorities between the advertisements A, E, and F are set by using distances between the location specified by the location information of the local device 200 and boundary lines of the respective reference areas of the advertisements A, E, and F.

FIGS. 6 to 9 are views respectively illustrating states in which the priorities for the advertisements B, C, and D are set by using the extra points in the priority setting module 140 of the advertisement service system for determining the priority for each advertisement by using the reference area and the tags according to the exemplary embodiment of the present disclosure.

First, as shown in FIG. 6, in a case where the advertisements B, C, and D are respectively tagged with “public” for the advertisement B, “history” for the advertisement C, and “newness and interest” for the advertisement D, when the total sum of the extra points for each advertisement is calculated while referring to FIG. 3 and the priorities of the advertisements are set in an order of higher extra points, the priorities may be set in an order of the advertisements D, B, and C in a first round, and the priorities may be set in an order of the advertisements D, C, and B in second and third rounds.

Next, the priorities between the advertisements A, E, and F, wherein the reference areas of the advertisements stored in the database module 110 do not include the location specified by the location information of the local device 200, may be set by using the distances between the position specified by the location information of the local device 200 and the boundary lines of the respective reference areas of the advertisements A, E, and F.

That is, when the reference areas of the advertisements stored in the database module 110 do not include the location specified by the location information of the local device 200, the priority setting module 140 may set the priorities of the advertisements in an order of the shortest distances between the position specified by the location information of the local device 200 and the boundary lines of the respective reference areas of the advertisements. As shown in FIG. 4, the reference areas A, E, and F do not include the location X specified by the location information of the local device 200. In this case, among these reference areas, with respect to the location X specified by the location information of the local device 200, in sequence, a shortest distance from the boundary line of the reference area F is the first shortest, a shortest distance from the boundary line of the reference area A is the next shortest, and a shortest distance from the boundary line of the reference area E is the last shortest. Accordingly, for the advertisements having the reference areas A, E, and F that do not include the location X specified by the location information of the local device 200, the priority setting module 140 may set the priorities of the advertisements in the order of the advertisements F, A, and E.

Finally, the priority setting module 140 sets the priorities of the advertisements in an order of the advertisements D, B, C, F, A, and E in a first round, and in an order of the advertisements D, C, B, F, A, and E in second and third rounds. In addition, the advertisement provision module 150 may arrange the advertisements stored in the database module 110 according to these orders and provide the advertisements to the local device 200.

According to the exemplary embodiment, when the shortest distances are the same, the priority setting module 140 may set the priorities of the advertisements in an order in which the reference areas of the advertisements are widest. Alternatively, when the shortest distances are the same, the priority setting module 140 may set the priorities of the advertisements in an order in which the reference areas of the advertisements are narrowest. In FIG. 4, in a case where the shortest distances between the boundary lines of the respective reference area A and the reference area E are the same with respect to the position X specified by the location information of the local device 200, the priority setting module 140 may set the advertisement E having the reference area E to have a higher priority than that of the advertisement A having the reference area A. The reason is that the reference area E is wider than the reference area A.

Meanwhile, the tag setting module 120 may periodically update and reset tags, and in particular, may update tags automatically selected according to advertisements such as newness, interest, etc. at regular intervals.

For example, as shown in FIG. 7, when users' interest levels, recommendation levels, and popularity levels for the advertisement B are high, the tag setting module 120 may set a tag of “interest” to the advertisement B. When a remaining condition is the same as in FIG. 6, the priority setting module 140 may set the priorities of the advertisements B, C, and D in an order of the advertisements B, D, and C in a first round, in an order of the advertisements D, B, and C in a second round, and in an order of the advertisements B, C, and D in a third round.

Then, finally, the priority setting module 140 sets the priorities of the advertisements in an order of the advertisements B, D, C, F, A, and E in a first round, in an order of the advertisements D, B, C, F, A, and E in a second round, and in an order of the advertisements B, C, D, F, A, and E in a third round. In addition, the advertisement provision module 150 may arrange the advertisements stored in the database module 110 according to these orders and provide the advertisements to the local device 200.

In addition, as shown in FIG. 8, when an advertisement B is newly added, the tag setting module 120 may set a tag of “newness” in the advertisement B. When the remaining condition is the same as in FIG. 6, the priority setting module 140 may set the advertisements B, C, and D in an order of the advertisements B, C, and D in a first round, in an order of the advertisements B, D, and C in a second round, and in an order of the advertisements D, C, and B in a third round.

Then, finally, the priority setting module 140 sets the priorities of the advertisements in an order of the advertisements B, C, D, F, A, and E in a first round, in an order of the advertisements B, D, C, F, A, and E in a second round, and in an order of the advertisements D, C, B, F, A, and E in a third round. In addition, the advertisement provision module 150 may arrange the advertisements stored in the database module 110 according to these orders and provide the advertisements to the local device 200.

As described with reference to FIGS. 6 to 8, even when the location specified by the location information of the local device 200 is fixed, extra points are changed and granted to tags according to the change criteria of the extra points, so the order of advertisements may be efficiently changed for each round of exposure. In addition, since the tag setting module 120 periodically changes the tags according to the characteristics of the tags and circumstances, the priorities may be dynamically changed by the tags even for the same advertisement. Accordingly, the advertisements may be provided in the order in which the advertisement effects of the entire advertisement output to the local device 200 may be increased and the users' interest in the advertisements may be kept high.

Meanwhile, a reference area of an advertisement may be a polygon or a circle. That is, the reference area of the advertisement may have various shapes. Referring to FIG. 4, the reference areas A, B, C, D, E, and F have areas having different shapes. In the advertisement service system for determining the priority for each advertisement by using the reference area and the tags according to the exemplary embodiment of the present disclosure, since the priorities of the advertisements may vary depending on whether or not the reference areas include the location X specified by location information of the local device 200, the priorities of the advertisements may vary depending on the shapes of the reference areas. That is, when a reference area is set in a shape including the specific location, a priority of an advertisement at the specific location may be set high even when the extent of the reference area is not wide. By setting the reference area to be polygonal or circular, an advertiser may set the reference area to include the location X specified by the location information of the local device 200 at the specific location.

Therefore, rather than simply setting the extent of a reference area wide without considering a location, the advertiser may expose an advertisement to users more efficiently at the specific location where the advertiser desires to carry out the advertisement.

In this case, at least a portion of the reference areas may overlap each other. Since reference areas of advertisements are set by advertisers through advertisers' devices, when the reference areas are set by a plurality of advertisers, at least some of the reference areas may overlap each other. Alternatively, even when one advertisement has a plurality of reference areas, at least a portion of the corresponding reference areas may overlap each other.

As described above, according to the advertisement service system for determining the priority for each advertisement by using the reference area and the tags, which are proposed in the present disclosure, the priority of each advertisement is set by using the reference area and the tags of each advertisement together, so that the priority for each advertisement is set according to the extra point granted to each tag, thereby solving the problem of using only the reference area and effectively setting the priority.

In addition, according to the advertisement service system for determining the priority for each advertisement by using the reference area and the tags, which are proposed in the present disclosure, the extra point granted to each tag is changed according to the change criteria different from each other for each tag, so that the priority may be set to increase the users' interest in the entire advertisement provided and maximally improve the advertisement effect.

The present disclosure described above can be modified or applied in various ways by those skilled in the art to which the present disclosure pertains. The scope of the technical idea according to the present disclosure should be defined by the following claims.

1. An advertisement service system for determining a priority for each advertisement by using a reference area and tags, the advertisement service system providing the advertisements and comprising:
a service provision server (100) configured to receive advertisement requests from a local device (200), and provide the advertisements to the local device (200),
wherein the service provision server (100) comprises:
a database module (110) configured to receive and store inputs of content to be displayed as the advertisements and the reference areas independent of a location of an advertiser;
a tag setting module (120) configured to set the tags in the advertisements;
an extra point granting module (130) configured to grant extra points to the respective tags, and change the extra points granted according to change criteria different from each other for each tag;
a priority setting module (140) configured to set priorities of the advertisements according to the reference areas and the extra points granted to the respective tags of the advertisements stored in the database module (110) on the basis of the location specified by location information of the local device (200); and
an advertisement provision module (150) configured to arrange the advertisements stored in the database module (110) according to the priorities set by the priority setting module (140) and provide the advertisements to the local device (200),
wherein the change criteria are preset according to characteristics of the tags,
the extra point granting module (130) changes the extra points according to the change criteria in which the extra points are set differently from each other according to each round of exposure or time of the advertisements,
the priority setting module (140) sets the priorities of the advertisements in which the reference areas of the advertisements stored in the database module (110) include the location specified by the location information of the local device (200) to be higher than the priorities of the advertisements in which the reference areas of the advertisements stored in the database module (110) do not include the location specified by the location information of the local device (200), and
the priority setting module (140) sets the priorities of the advertisements according to the extra points granted to the respective tags set in the advertisements when the reference areas of the advertisements stored in the database module (110) include the location specified by the location information of the local device (200).

2. The advertisement service system of claim 1, wherein the tag setting module (120) sets, to the advertisements, at least one or more tags among tags selected by the advertiser and tags automatically selected according to the advertisements.

3. The advertisement service system of claim 2, wherein the tag setting module (120) periodically updates and resets the tags automatically selected according to the advertisements.

4. The advertisement service system of claim 1, wherein the priority setting module (140) sets the priorities of the advertisements in an order in which the extra points granted to the respective tags set in the advertisements are highest.

5. The advertisement service system of claim 1, wherein, when the reference areas of the advertisements stored in the database module (110) do not include the location specified by the location information of the local device (200), the priority setting module (140) sets the priorities of the advertisements in an order in which shortest distances between the position specified by the location information of the local device (200) and boundary lines of the respective reference areas of the advertisements are shortest.

6. The advertisement service system of claim 5, wherein, when the shortest distances are the same, the priority setting module (140) sets the priorities of the advertisements in an order in which the reference areas of the advertisements are widest.
